(19) United States
(12) Patent Application Publication
(10) Pub. No.: US 2026/0246982 A1
(43) Pub. Date: Aug. 20, 2026

(54) REAL TIME INLINE STREAM INSPECTIONS

(71) Applicant: NETFLIX, INC., Los Gatos, CA (US)

(72) Inventors: Xiaomei LIU, Cupertino, CA (US); Cyril Denis Mario CONCOLATO, Palo Alto, CA (US)

(21) Appl. No.: 19/347,629

(22) Filed: Oct. 1, 2025

Related U.S. Application Data
(60) Provisional application No. 63/758,996, filed on Feb. 14, 2025.

(51) Int. Cl. H04N 21/2187; H04N 21/234; H04N 21/4425; H04N 21/488; H04N 21/845

(52) U.S. Cl. CPC H04N 21/2187; H04N 21/23424; H04N 21/4425; H04N 21/4884; H04N 21/845

(57) ABSTRACT

One embodiment sets forth a method for performing real-time inline inspections of livestream media. According to some embodiments, the method can include the steps of obtaining, by a packager, a livestream segment generated by an encoder; inspecting, by an inline inspection module operating within the packager, the livestream segment in real time based on information associated with the livestream segment; and classifying, by the inline inspection module, any error identified during the inspection to determine at least one remedial action.

### CROSS-REFERENCE TO RELATED APPLICATIONS

This application claims benefit of the United States Provisional Patent Application titled “TECHNIQUES FOR IMPLEMENTING REAL TIME INLINE STREAM INSPECTION USING A LIVE PACKAGER,” filed February 14, 2025, and having serial number 63/758,996. The subject matter of this related application is hereby incorporated herein by reference.

### BACKGROUND

### Field of the Invention

The contemplated embodiments relate generally to computer science and streaming and video processing technologies and, more specifically, to real time inline stream inspections, including all of the hardware, software, and algorithms relevant to implementing all systems, functions, and operations contemplated herein.

### Description of the Related Art

Video-on-Demand (VOD) platforms deliver complete media files that can be validated and inspected for errors prior to distribution. Livestreaming platforms, by contrast, deliver media in real time as an event unfolds, which can make it difficult to perform such pre-distribution inspections. Rather, live media is encoded into short segments that are continuously generated and transmitted. In a typical workflow, an encoder generates multiple variant streams at different bitrates and/or resolutions, where each variant stream is divided into discrete segments. A packager then wraps each segment into containers and generates manifests or playlists to direct client playback. The packaged segments and manifest files are published to a server and propagated through edge-cache networks, such as content distribution networks (CDNs), for delivery to client playback applications. Because this process occurs in real time, errors such as segment discontinuities, timing drifts, or formatting violations may not be detected until they affect the viewer experience.

Conventional techniques for performing real-time error inspection of a livestream involve duplicating – commonly referred to as “forking” – the encoder output to a separate monitoring and inspection environment. In practice, each encoded livestream segment, often across multiple bitrate segments, is replicated and delivered to two concurrent paths: a dedicated monitoring and inspection environment and a packager pipeline. In Hypertext Transfer Protocol (HTTP) based deployments, such replication is implemented as parallel requests for the same bitrate segment, where two HTTP transfers are issued such that both the packager pipeline and the dedicated monitoring and inspection environment receive a copy of the bitrate segments. The dedicated monitoring and inspection environment then extracts metadata and performs inspection and error checks on the duplicated encoded livestream segment.

One drawback of the approach involving a separate monitoring and inspection environment is that such an environment consumes additional bandwidth, processing capacity, and energy resources. For example, for each variant of a given livestream segment, the encoder must duplicate the segment into copies that are delivered to both the packager pipeline and the monitoring and inspection environment, which requires additional processing resources. In systems where the encoder cannot share a single output path, the duplication requires a separate output (e.g., a non-shared encoding path), such that the forked livestream segment may not be fully synchronized or may not contain exactly the same data (e.g., bit-exact) in practice, which can introduce further divergence between what is inspected and what is packaged. Such duplication doubles bandwidth and compute requirements for livestream segment delivery and parsing, which can increase processor utilization and network strain. Moreover, provisioning and maintaining a dedicated monitoring and inspection environment increases architectural complexity, which can require additional scaling policies and logs across disparate systems and can create additional scenarios where errors may arise.

Another drawback of the foregoing approach is that inspecting forked livestream segments fails to capture the exact delivery conditions experienced by the viewers, which can undermine the overall reliability and efficacy of error detection. More specifically, because the forked livestream segment traverses a separate network path, the forked livestream segment does not reflect any packet loss, jitter, or latency anomalies on a primary delivery route to the viewers. Additionally, the forked streams might apply validation rules that differ from the acceptance criteria of the packager, which can result in false positives or missed errors when mismatches occur. Moreover, the absence of bit-exact inspection allows network discontinuities and downstream formatting issues to go undetected, which can cause the livestream to exhibit errors and manifest inconsistencies that may only become apparent during playback.

As the foregoing illustrates, what is needed in the art are more effective techniques for inspecting livestreams.

### SUMMARY OF THE EMBODIMENTS

One embodiment sets forth a method for performing real-time inline inspections of livestream media. According to some embodiments, the method can include the steps of obtaining, by a packager, a livestream segment generated by an encoder; inspecting, by an inline inspection module operating within the packager, the livestream segment in real time based on information associated with the livestream segment; and classifying, by the inline inspection module, any error identified during the inspection to determine at least one remedial action.

Other embodiments of the present disclosure include, without limitation, one or more computer-readable media including instructions for performing one or more aspects of the disclosed techniques as well as a computing device for performing one or more aspects of the disclosed techniques.

At least one technical advantage of the disclosed techniques relative to the prior art is that the disclosed techniques enable real time inline inspection within a packager pipeline, thereby eliminating the need for a separate monitoring and inspection environment and duplication of livestream segments. The elimination of duplicate requests reduces network bandwidth consumption and decreases processing overhead previously necessary for parsing forked streams. Another technical advantage of the disclosed techniques over the prior art is that the disclosed techniques facilitate inspection of bit-exact livestream segments and capture errors in real time rather than relying on a forked feed of livestream segments. Such real-time error capture can help reduce or eliminate false positives and false negatives with respect to error detections. Therefore, livestream segments can be more accurately confirmed as error-free and compliant with the required format at publish time.

These technical advantages represent one or more technological advancements over prior art approaches.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a conceptual illustration of a system that is configured to implement one or more aspects of the various embodiments.

FIG. 2 is a conceptual illustration of a livestream data flow that can be executed by the system of FIG. 1, according to various embodiments.

FIG. 3 is a more detailed illustration of the packager of FIG. 2, according to various embodiments.

FIG. 4 illustrates a flow diagram of a method for real-time inline segment inspection of a given variant stream, according to various embodiments.

FIG. 5 illustrates a flow diagram of a method for an error handling routine within a packaging pipeline, according to various embodiments.

FIG. 6 illustrates a flow diagram of a method for smart-origin processing pipeline selection, according to various embodiments.

FIG. 7 illustrates a network infrastructure used to distribute content to content servers and endpoint devices, according to various embodiments of the invention.

FIG. 8 is a block diagram of a content server that may be implemented in conjunction with the network infrastructure of FIG. 7, according to various embodiments of the present invention.

FIG. 9 is a block diagram of a control server that may be implemented in conjunction with the network infrastructure of FIG. 7, according to various embodiments of the present invention.

FIG. 10 is a block diagram of an endpoint device that may be implemented in conjunction with the network infrastructure of FIG. 7, according to various embodiments of the present invention.

### DETAILED DESCRIPTION

In the following description, numerous specific details are set forth to provide a more thorough understanding of the present disclosure. However, it will be apparent to one skilled in the art that the present disclosure may be practiced without one or more of these specific details.

Video-on-Demand (VOD) platforms deliver complete media files that can be validated and inspected for errors prior to distribution. Livestreaming platforms, by contrast, deliver media in real time as an event unfolds, which can make it difficult to perform such pre-distribution inspections. Rather, live media is encoded into short segments that are continuously generated and transmitted. In a typical workflow, an encoder generates multiple variant streams at different bitrates and/or resolutions, where each variant stream is divided into discrete segments. A packager then wraps each segment into containers and generates manifests or playlists to direct client playback. The packaged segments and manifest files are published to a server and propagated through edge-cache networks, such as content distribution networks (CDNs), for delivery to client playback applications. Because this process occurs in real time, errors such as segment discontinuities, timing drifts, or formatting violations may not be detected until they affect the viewer experience.

Conventional techniques for performing real-time error inspection of a livestream involve duplicating – commonly referred to as “forking” – the encoder output to a separate monitoring and inspection environment. In practice, each encoded livestream segment, often across multiple bitrate segments, is replicated and delivered to two concurrent paths: a dedicated monitoring and inspection environment and a packager pipeline. In HTTP-based deployments, such replication is implemented as parallel requests for the same bitrate segment, where two HTTP transfers are issued such that both the packager pipeline and the dedicated monitoring and inspection environment receive a copy of the bitrate segments. The dedicated monitoring and inspection environment then extracts metadata and performs inspection and error checks on the duplicated encoded livestream segment.

One drawback of the approach involving a separate monitoring and inspection environment is that such an environment consumes additional bandwidth, processing capacity, and energy resources. For example, for each variant of a given livestream segment, the encoder must duplicate the segment into copies that are delivered to both the packager pipeline and the monitoring and inspection environment, which requires additional processing resources. In systems where the encoder cannot share a single output path, the duplication requires a separate output (e.g., a non-shared encoding path), such that the forked livestream segment may not be fully synchronized or may not contain exactly the same data (e.g., bit-exact) in practice, which can introduce further divergence between what is inspected and what is packaged. Such duplication doubles bandwidth and compute requirements for livestream segment delivery and parsing, which can increase processor utilization and network strain. Moreover, provisioning and maintaining a dedicated monitoring and inspection environment increases architectural complexity, which can require additional scaling policies and logs across disparate systems and can create additional scenarios where errors may arise.

Another drawback of the foregoing approach is that inspecting forked livestream segments fails to capture the exact delivery conditions experienced by the viewers, which can undermine the overall reliability and efficacy of error detection. More specifically, because the forked livestream segment traverses a separate network path, the forked livestream segment does not reflect any packet loss, jitter, or latency anomalies on a primary delivery route to the viewers. Additionally, the forked streams might apply validation rules that differ from the acceptance criteria of the packager, which can result in false positives or missed errors when mismatches occur. Moreover, the absence of bit-exact inspection allows network discontinuities and downstream formatting issues to go undetected, which can cause the livestream to exhibit errors and manifest inconsistencies that may only become apparent during playback.

To address these issues, an encoder generates encoded livestream segments, which are then received and processed by a packager. Prior to final packaging of each livestream segment, an inline inspection module extracts and maintains relevant metadata fields and a stream context of previous metadata fields. The inline inspection module then compares the relevant metadata fields against the stream context to identify at least one error. Upon identifying an error, the disclosed techniques enable a responsive action and propagation of alerts upstream and/or downstream, where appropriate. Errors that are actionable in real time can trigger downstream remediations. Remediation can include, for example, switching to an error-free livestream via a different processing pipeline. Unresolved or non-real-time upstream errors can inform pre-livestream parameter adjustments to improve subsequent livestream quality. Livestream segments that pass inspection are packaged and forwarded downstream to origin servers, CDN edges, and ultimately clients.

At least one technical advantage of the disclosed techniques relative to the prior art is that the disclosed techniques enable real time inline inspection within a packager pipeline, thereby eliminating the need for a separate monitoring and inspection environment and duplication of livestream segments. The elimination of duplicate requests reduces network bandwidth consumption and decreases processing overhead previously necessary for parsing forked streams. Another technical advantage of the disclosed techniques over the prior art is that the disclosed techniques facilitate inspection of bit-exact livestream segments and capture errors in real time rather than relying on a forked feed of livestream segments. Such real-time error capture can help reduce or eliminate false positives and false negatives with respect to error detections. Therefore, livestream segments can be more accurately confirmed as error-free and compliant with the required format at publish time. These technical advantages provide one or more technological advancements over prior art approaches.

### System Overview

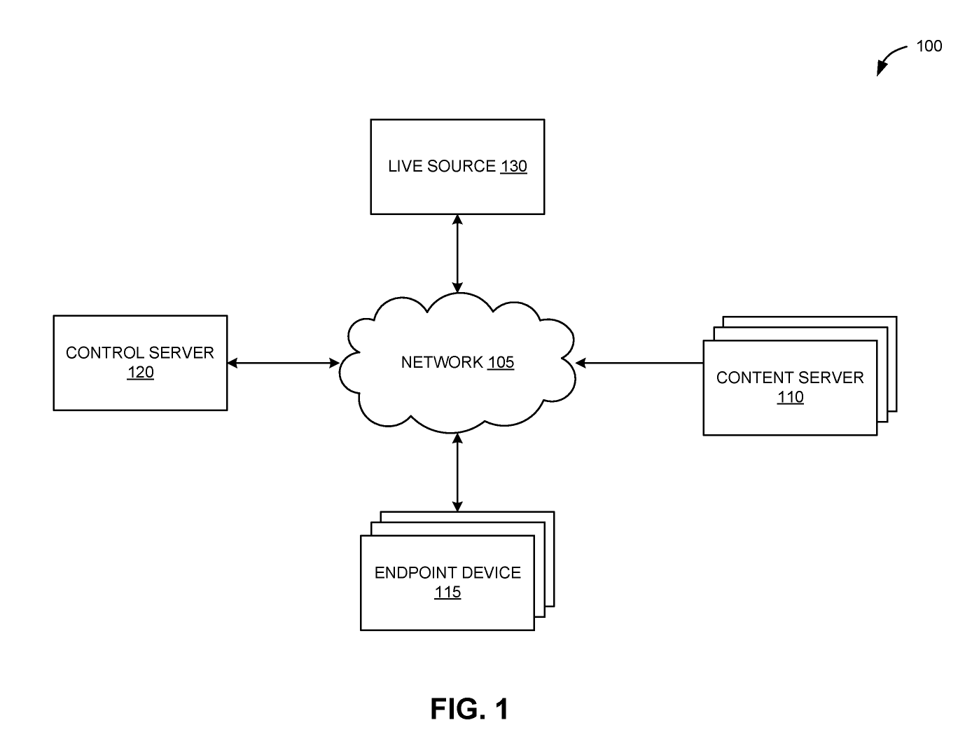

FIG. 1 illustrates a network infrastructure 100 used to distribute livestream content to content servers 110 and endpoint devices 115, according to various embodiments of the invention. As shown, the network infrastructure 100 includes content servers 110, a control server 120, endpoint devices 115, and a live source 130, each of which are connected via a communications network 105.

Each endpoint device 115 communicates with one or more content servers 110 (also referred to as “caches” or “nodes”) via the network 105 to download content, such as textual data, graphical data, audio data, video data, and other types of data. Further, each endpoint device 115 can communicate with the content servers 110 to download livestream content, such as livestream video data, livestream audio data, and other types of livestream data. The downloadable content, also referred to herein as a “file” or a “livestream segment,” is then presented to a user of one or more endpoint devices 115.

In various embodiments, the endpoint devices 115 may include computer systems, set-top boxes, mobile computers, smartphones, tablets, console and handheld video game systems, digital video recorders (DVRs), DVD players, connected digital TVs, dedicated media streaming devices (e.g., a Roku® set-top box), and/or any other technically feasible computing platform that has network connectivity and is capable of presenting content that encompasses text, images, video, and/or audio content to a user.

Each content server 110 may include a web server, a database, and a server application (not shown) configured to communicate with the control server 120 to determine the location and availability of various files (e.g., livestream segments) that the control server 120 tracks and manages.

In addition, content servers 110 may respond to requests for files received from endpoint devices 115. The files may then be distributed from the content servers 110 or via a broader content distribution network. In some embodiments, the content servers 110 enable users to authenticate (e.g., using a username and password) in order to access files stored on the content servers 110.

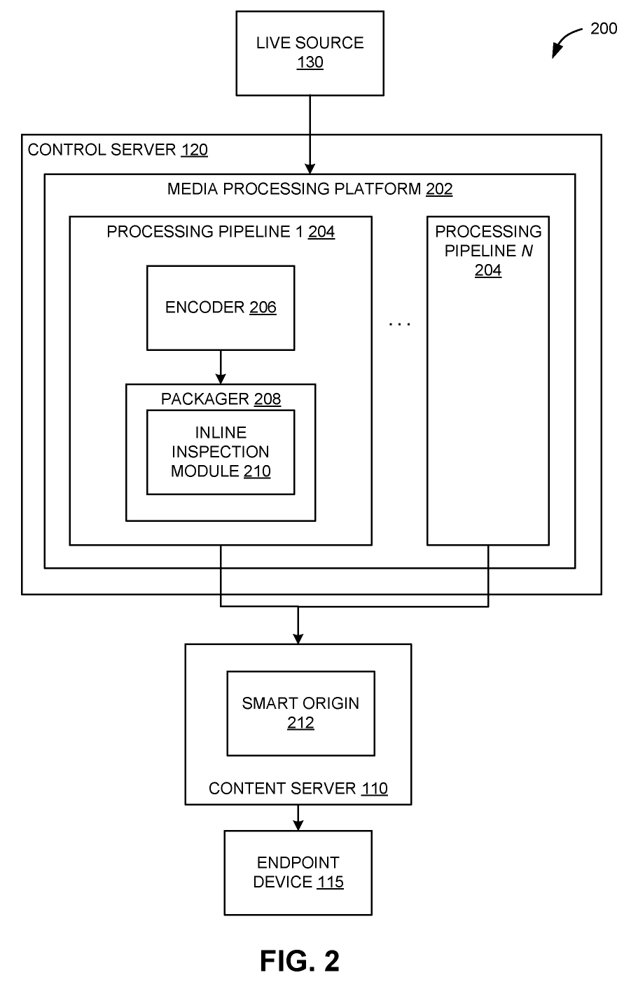

In some embodiments, the content servers 110 can include one or more origin servers, smart origin servers, and/or distributed edge-cache nodes that receive files, such as a packaged livestream output from the control server 120, and serve such files to the endpoint device 115. A smart origin server is a type of origin server configured with logic for handling livestream segment delivery. Unlike conventional origin servers that serve requested files, the smart origin server can interpret inline inspection results, apply downstream error remediation policies, and dynamically select packaged livestream segments to serve. The smart origin server is described in further detail in conjunction with FIG. 2. The packaged media includes a series of livestream segments (e.g., Common Media Application Format (CMAF) compliant MP4). In some embodiments, the livestream segments include an initialization fragment containing file-level and track-level metadata, in addition to a series of media fragments, each with a media fragment header and associated media data box, optionally embedding event messages or encryption initialization information.

As used herein, the term “inline” refers to operations that are performed within the primary processing pipeline of the livestream media, and not to operations performed on media segments forked or otherwise diverted to a separate monitoring environment. In one example, inline inspections may occur in the same execution path as normal packaging functions. By contrast, conventional “forked” inspection approaches duplicate encoder output into a parallel path, thereby introducing divergence between what is inspected and what is packaged.

In operation for adaptive bitrate delivery, the content server 110 hosts protocol manifests that enumerate all available variant streams (herein referred to as variants). The manifest specifies segment durations and either a start or explicit Uniform Resource Locator (URL) with a template URL for subsequent segment retrieval, or alternatively provides explicit Uniform Resource Identifiers (URIs) for each segment. In some embodiments, the variant streams encompass multiple renditions of the same content, differing in bitrate, resolution, codec profile (e.g., H.264 vs. H.265), audio configurations (e.g., stereo vs. 5.1, multiple language tracks), subtitle or caption streams, and/or other encoding or presentation parameters.

In some embodiments, the endpoint device 115 can use a master manifest to discover variant streams, request the initialization fragment, and then sequentially retrieve media fragments (e.g., livestream segments) via HTTP GET to reconstruct a continuous playback timeline of livestream segments. In some embodiments, edge caches included in the content server 110 respond to requests from geographically proximate nodes, and can periodically refresh manifests from the origin server to maintain low latency and bitrate switching.

The control server 120 is described in further detail below in conjunction with FIG. 2. Although only a single control server 120 is shown in FIG. 1, in various embodiments multiple control servers 120 may be implemented to track, process, and manage files (e.g., livestream segments).

The live source 130 includes the processes by which raw media is captured and composited into a live feed. In operation, one or more camera feeds are selected (via a manual director control or automated routing logic) and combined with auxiliary video layers, such as branding graphics, real-time score overlays, and/or generated captions. In some embodiments, subtitle and closed-caption streams are produced and formatted, and Society of Cable Telecommunications Engineers - Standard 35 (SCTE-35) cue messages are injected at designated temporal offsets to mark ad breaks or program transitions. SCTE-35 cue messages are standardized metadata packets inserted into the live feed that carry a splice event identifier, timing information, and optional descriptors (such as a break duration). SCTE-35 cue messages signal precise splice points, typically the start or end of an ad break, so the packager can verify alignment with a key frame and enable downstream ad insertion.

In some embodiments, the composited elements are multiplexed into a single, composite media feed conformant to contribution-layer transport protocols (e.g., Secure Reliable Transport (SRT), Zixi, etc.) and delivered over network 105 to the control server 120. At the control server 120, the composite feed becomes the input for subsequent real-time encoding, inline inspection, packaging, and origination.

FIG. 2 is a conceptual illustration of a livestream data flow 200 that can be implemented by the system of FIG. 1, according to various embodiments. As shown, the livestream data flow 200 includes a live source 130, a control server 120, a content server 110, and an endpoint device 115. The control server 120 includes, without limitation, a media processing platform 202. The content server 110 includes, without limitation, a smart origin server 212.

The live source 130 includes the raw media and implements processes that generate a composite media feed for processing by the control server 120. In operation, one or more camera signals that include raw media are selected and routed into a graphics engine where live overlays (e.g., branding graphics, motion titles, real-time scoreboards, etc.) are rendered. In some embodiments, closed-caption and subtitle streams are generated and formatted, additional audio language tracks are multiplexed, and SCTE-35 cue messages are injected at designated splice points to mark ad breaks or program transitions. All of these elements are combined into a single, time-synchronized composite media feed and delivered over network 105 to the control server 120.

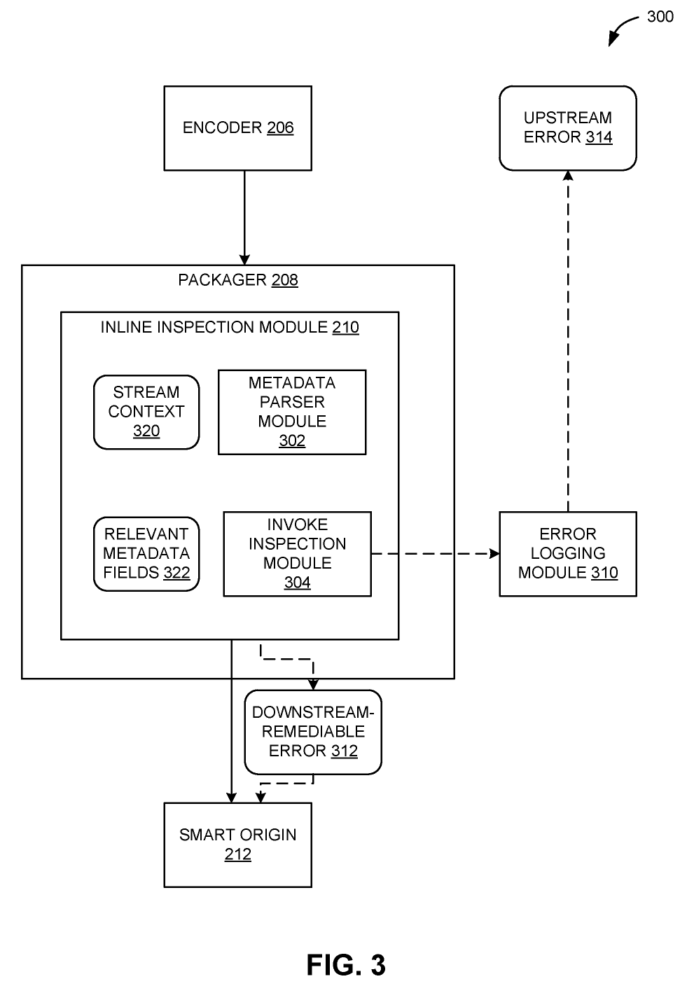

The control server 120 serves as a central processing and distribution point for the livestream data flow 200. Upon receipt of the composite media feed from the live source 130, the control server 120 receives the incoming composite media feed, retrieves any required encryption keys or Digital Rights Management (DRM) policies, and provisions encoding and packaging parameters, including bitrate ladder definitions, segment duration, manifest templates, and inline-inspection thresholds, which are described in further detail below in conjunction with FIG. 3.

As shown in FIG. 2, the control server 120 implements N processing pipelines 204 within a media processing platform 202, and supplies each processing pipeline 204 with the composite media feed and associated metadata. As shown in FIG. 2, each processing pipeline 204 implements an encoder 206 to transcode the composite media feed into multiple livestream segments, each at multiple bitrates. The livestream segments are provided to a packager 208, which implements an inline inspection module 210 to check for errors. After checking for errors, the packager 208 packages the livestream segments by containerizing the livestream segments into fragmented-MP4, applying any DRM or format adaptations, and updating one or more associated manifests. The inline inspection module 210, encoder 206, and packager 208 are described in further detail below in conjunction with FIG. 3.

According to some embodiments, the control server 120 can implement post-processing tasks such as manifest sanitization, live-event analytics collection, and dynamic ad-decisioning before forwarding the livestream segments to the content server 110 for distribution to the endpoint devices 115.

As shown in FIG. 2, the outputs of the pipelines 204 are delivered to a smart origin server 212. As discussed in greater detail below in conjunction with FIG. 3, the smart origin server 212 continuously evaluates inspection flags produced by the inline inspection module 210 on each incoming livestream feed associated with a pipeline 204 and selects the least error-prone processing pipeline 204 for publication to content distribution nodes. In some embodiments, the smart origin server 212 may instead elect not to publish a flagged segment when no error-free alternative is available, thereby signaling a discontinuity and allowing client playback devices to perform error-concealment strategies.

The content server 110 includes one or more smart origin server 212 and edge-cache nodes that persist and serve the livestream segments to the endpoint device 115. The smart origin server 212 consolidates the outputs of the processing pipelines 204 for distribution. In some embodiments, the smart origin server 212 receives HTTP GET requests for livestream segments from downstream nodes such as a content distribution network (CDN) edge caches or endpoint device 115.

The smart origin server 212 evaluates error indicators as described in greater detail in conjunction with FIG. 3. Upon detecting a flagged error in a primary processing pipeline 204, the smart origin server 212 selects the least error prone segment among the processing pipelines 204.

Upon receiving a request for a master or variant manifest, the smart origin server 212 retrieves the latest manifest model, updates live-edge pointers, and returns the manifest with appropriate cache-control directives to maintain a sliding live window. In some embodiments, when handling livestream segment fetch requests, the smart origin server 212 locates the requested livestream segment, and serves the livestream segment with the correct HTTP headers (e.g., Content-Type, Cache-Control, EXT-X-PREFETCH-HINT). In some embodiments, the smart origin server 212 enforces access-control policies, such as token validation or geographic restrictions, and proxies DRM license acquisitions to external key servers.

In some embodiments, independent to smart origin server 212 operation, the content server 110 responds to client HTTP requests for initialization fragments and media segments (e.g., livestream segments), enforcing cache-control directives to maintain a rolling live-edge window and purging livestream segments that fall outside of the playback buffer. In some embodiments, the content server 110 delivers updated manifests (e.g., HTTP Live Streaming (HLS) playlists or Dynamic Adaptive Streaming over HTTP (DASH) Media Presentation Descriptions (MPDs)) at each manifest-reload interval, injects server-side ad-decision tags when applicable, and proxies DRM key requests to license servers.

The content server 110 propagates the packaged livestream segments and manifests through CDN edge caches and delivers the packaged livestream segments to endpoint devices 115. At the endpoint devices 115, client players fetch manifests, download livestream segments, and render the livestream.

Although FIG. 2 depicts the media processing platform 202 associated subcomponents, and the smart origin server 212 as distinct logical blocks mapped to server entities (e.g., live source 130, control server 120, content server 110, and endpoint device 115), it will be understood that such functions may be co-located, distributed, or re-assigned across any combination of physical or virtual servers within a cloud or on-premises environment. Further, the composite media feed and related pre-processing may execute on the same server as the encoder 206 and packager 208 or on separate servers. Similarly, inline inspection, packaging, manifest generation, and origin logic may be consolidated on a single server or spread across dedicated nodes. Any server or service may assume the responsibilities of another without departing from the scope of this disclosure.

FIG. 3 is a more detailed illustration 300 of the packager of FIG. 2, according to various embodiments. As shown, FIG. 3 includes an encoder 206, a packager 208, a smart origin server 212, an error logging module 310, a downstream-remediable error 312, and an upstream error 314.

The encoder 206 receives a composite live feed from a control server 120 and transcodes the input into one or more variant streams (e.g., at different bitrates and resolutions). In operation, the encoder 206 decodes the incoming transport stream (e.g., UDP, SRT), applies a video compression algorithm (such as H.264 or H.265) and audio compression (such as AAC) according to configured encoding profiles. The encoder 206 then outputs continuous codec-compliant livestream segments for each variant stream as fixed-duration segments (typically 1-4 seconds in length). The fragmented-MP4 livestream segments are forwarded to the packager 208 for inline inspection and packaging. In some embodiments, the encoder 206 may also insert in-band metadata such as SCTE-35 cue messages or supplemental descriptor messages before segmentation, enabling downstream alignment checks.

The packager 208 receives fragmented-MP4 livestream segments from the encoder 206 and performs the necessary containerization, format adaptation, and manifest generation to prepare the segments for client delivery. Subsequent to receiving the fragmented-MP4 livestream segments, the inline inspection module 210 operates within packager 208 prior to containerization and manifest updates to perform real-time error checks on each incoming livestream segment, discussed further below.

The inline inspection module 210 executes in the packager 208 as a pre-packaging processing stage that continuously monitors each incoming livestream segment in real time. The inline inspection module 210 analyzes the segment before containerization, extracts and normalizes relevant metadata fields 322, and evaluates the livestream segment against a variety of pre-configured inspection routines. The inline inspection module 210 supports a configurable suite of pre-configured inspection routines, which are described in greater detail in the section below.

The inline inspection module 210 operates in a two-phase workflow: a data-collection phase, during which a metadata parser module 302 extracts and normalizes relevant metadata fields 322 from each incoming livestream segment, and an analysis phase, during which an invoke inspection module 304 applies a suite of pre-configured inspection routines against relevant metadata fields 322 and a stored stream context 320.

The stored stream context 320 refers to a persistent data structure maintained by the inline inspection module 210 for each variant stream that stores relevant metadata fields 322. Upon receipt of the first livestream segment for a given variant, a corresponding stream context 320 is instantiated and initialized with relevant metadata fields 322 corresponding to the first livestream segment. After each subsequent livestream segment is parsed, the stored stream context 320 is updated, optionally overwriting prior relevant metadata fields 322, to reflect a most recent livestream segment state. In some embodiments, the stream context 320 retains relevant metadata fields 322 of a previous livestream segment or maintains a sliding-window buffer of the last N relevant metadata fields 322, enabling multi-segment analyses, such as long-term drift detection, trend-based anomaly scoring, and cross-segment synchronization checks. In some embodiments, the stream context 320 can include cross-track checks such as validation that a video stream contains a keyframe at the same time location as the keyframe indicated in the SCTE track.

In operation, the metadata parser module 302 implements the data-collection phase of inline inspection. Upon receipt of each fragmented-MP4 livestream segment from the encoder 206, the metadata parser module 302 extracts and normalizes the relevant metadata fields 322. The relevant metadata fields 322 are determined by the selection of pre-configured inspection routines. Specific relevant metadata fields 322 corresponding to pre-configured inspection routines are discussed in greater detail in the section below. Briefly, in some embodiments, examples of the relevant metadata fields 322 can include a segment sequence number, a track fragment decode time (tfdt), in-band SCTE-35 cue timestamps, and audio/video start timestamps. It is noted that the foregoing examples are not meant to be limiting, and that the relevant metadata fields 322 can include any number, type, form, etc., of fields, at any level of granularity, consistent with the scope of this disclosure.

In some embodiments, the metadata parser module 302 assembles the relevant metadata fields 322 into a data structure that includes the livestream segment and the relevant metadata fields 322. In some embodiments, parsing and field extraction occur in a single, linear pass over the livestream segment data.

The invoke inspection module 304 implements the analysis phase of inline inspection by applying one or more pre-configured inspection routines to the data structure that includes the livestream segment, the relevant metadata fields 322 and the stream context 320. For each incoming data structure that includes the livestream segment and relevant metadata fields 322, the invoke inspection module 304 retrieves the corresponding stream context 320 and executes each pre-configured inspection routine (e.g., as described in greater detail in the section below). As the pre-configured inspection routines are independent from each other, each pre-configured inspection routine can be executed in any configured order. The results of the invoke inspection module 304 are encapsulated and forwarded to an error logging module 310 for remediation.

Returning now to the packager 208, subsequent to inline inspection module 210 execution, the packager 208 wraps each movie fragment header (moof) and media data (mdat) pair into a CMAF-compliant media segments. Common Media Application Format (CMAF) defines a standardized fragmented-MP4 structure for HTTP delivery, where each livestream segment comprises one or more moof/mdat boxes. The packager 208 then applies any configured DRM encryption or key-rotation schemes, and constructs or updates protocol manifests reflecting current live-edge sequence numbers and timing information. In some embodiments, the packager 208 also inserts segment-level metadata (e.g., encryption licenses, ad-decision tags, or HTTP prefetch hints) and enforces cache-control directives to support low-latency edge caching. Once packaging is complete, the packager 208 forwards the ready-to-serve livestream segments and updated manifests to the smart origin server 212 for downstream distribution.

The error logging module 310 receives the results of the invoke inspection module 304 and records and propagates inspection outcomes. For each result, if an error is detected, the error logging module 310 determines whether the error is a downstream-remediable error 312 or an upstream error 314 and formats a corresponding response. If the downstream-remediable error 312 is determined, the error logging module 310 attaches a specific HTTP header to the livestream segment response, enabling the smart origin server 212 to detect and act on the error in real time. The upstream errors 314 are recorded in an operational log or telemetry system, triggering alerts or metrics for encoder-parameter tuning and offline analysis. In some embodiments, the packager 208 can reject the livestream segment to trigger a retry by the encoder 206. In some embodiments, operator intervention can be utilized to adjust and fix future livestream segments. In all cases, the error logging module 310 generates a timestamped entry, containing the variant identifier, livestream segment sequence, error type, and contextual metadata to a centralized repository.

The upstream error 314 represents any inspection failure that, while detected in real time, is not correctable by downstream delivery logic and instead requires adjustments to upstream encoding parameters or offline operator intervention. Examples can include minor audio/video synchronization drift, small deviations from template-publish cadence, or transient sample-count variance within allowable tolerances. When the invoke inspection module 304 flags such an error, the error logging module 310 generates an upstream error 314 entry and forwards the error via an alerting interface to the control server 120 or a designated monitoring system.

The downstream-remediable error 312 represents any inspection failure that can be addressed through real-time downstream delivery logic. Typical examples include segment-number discontinuity, timing continuity failures, sample-count mismatches, and fragment validity violations. When the invoke inspection module 304 flags such an error, error logging module 310 attaches a specific HTTP response header to the affected livestream segment outgoing response. This header propagates with the segment into the smart origin server 212 (or other downstream distribution components), enabling immediate corrective actions, such as pipeline switching, manifest discontinuity signaling, or client-side error concealment.

The smart origin server 212 consumes downstream-remediable error 312 headers attached by the error logging module 310 to incoming livestream segments and uses the header information to drive real-time delivery decisions. In some embodiments, upon receiving a livestream segment request from a CDN edge or client, the smart origin server 212 fetches the corresponding segments from active processing pipelines 204 and inspects each error header. If a segment from a primary processing pipeline 204 carries a downstream-remediable error 312 flag, the smart origin server 212 switches to an alternate processing pipeline 204 containing a livestream segment that passed inspection. In some embodiments, the smart origin server 212 can translate error flags into manifest directives, such as inserting a tag to inform clients of non-fatal livestream changes and enable error concealment.

In some embodiments, in response to a downstream-remediable error 312, the smart origin server 212 inserts discontinuity indicators into the manifest to signal downstream players or CDNs that a deliberate gap or switch point has occurred. For example, in HLS the smart origin server 212 (or packager 208) injects a tag at the affected sequence number. Upon encountering these indicators, compliant clients reset their decoder state, flushing any pending frames or buffers and begin decoding at the next livestream segment boundary, preventing decoder errors or drift.

In some embodiments, the smart origin server 212 can enable client-side error concealment to mask errors. Depending on the error type and client capabilities, the smart origin server 212 can indicate the error type, thereby enabling the players to execute client side error concealment, such as freezing a last successfully decoded frame until a next error-free livestream segment arrives, splicing in a “freeze” filler livestream segment, performing an audio cross-fade or silent-gap fill to bridge missing audio, or automatically retrying a failed livestream segment fetch without user-visible interruption.

### Pre-Configured Inspection Routines

The following are examples of pre-configured inline inspection routines that may be executed by an inline inspection module 210 prior to packaging each livestream segment. These example checks are provided as examples and should not be construed as limiting the scope of potential inspection routines that the module may perform.

In a segment number discontinuity check, the inline inspection module 210 extracts the sequence number from each incoming livestream segment header and compares the sequence numbers against a previously recorded sequence number for each variant. When the first segment for a variant is received, the inline inspection module 210 initializes a stream context with the sequence number of the livestream segment. For every subsequent livestream segment, the inline inspection module 210 verifies that the new sequence number equals the last stored sequence number + 1. If the sequence number deviates, indicating a missing, duplicated, or out-of-order segment, the inline inspection module 210 classifies the discrepancy as a discontinuity error and generates an inspection result reflecting the variant identifier, expected and actual sequence numbers, and error type. Because a gap or overlap in livestream segment numbering directly disrupts playback continuity, such an error is classified as a downstream-remediable error 312, which triggers an error header that enables the smart origin to switch to a healthy processing pipeline 204 in real time.

In a segment timing discontinuity check, the inline inspection module 210 reads the track fragment decode time (tfdt) from each incoming fragmented-MP4 livestream segment and compares the tfdt against the sum of the previous live segment tfdt and an associated duration. For each subsequent livestream segment, the inline inspection module 210 checks whether the new livestream segment decode time equals the previously recorded decode time plus the previously recorded duration. When the new livestream segment decode time deviates from this expected value, indicating a gap or overlap in decode timing, the inline inspection module 210 generates an inspection result capturing the expected decode time, the actual decode time, and the magnitude of the discrepancy. Any timing discontinuity is classified as a downstream-remediable error 312, causing the inline inspection module 210 to attach an error header so that the smart origin server 212 can switch processing pipelines for the livestream segment or insert a manifest discontinuity marker for client concealment.

In a segment sample-count discontinuity check, the inline inspection module 210 determines the expected number of frames or audio samples for each segment based on the configured constant segment duration and the variant frame rate or sample rate. The inline inspection module 210 then parses the livestream segment track-run box (trun) to extract the actual sample-count value. When the extracted sample-count value does not match the expected count, excluding the final livestream segment of an event, the inline inspection module 210 generates an inspection result containing the expected and actual counts and an error identifier. This discrepancy is classified as a downstream-remediable error 312, which causes the inline inspection module 210 to attach an error header so that Smart origin server 212 can switch to a healthy pipeline feed or insert a discontinuity marker in the manifest.

In a SCTE-35 ads-marker/IDR alignment check, the inline inspection module 210 parses in-band SCTE-35 cue messages from the event track and correlates each cue timestamp with the closest video frame boundary in the corresponding media segment. The inline inspection module 210 then examines the codec sample flags of the frame or (Network Abstraction Layer) NAL unit headers to verify that the frame is an instantaneous decoder refresh (IDR) frame. When the signaled splice point does not align with an IDR frame, indicating a potential artifact during ad insertion, the inline inspection module 210 generates an inspection result containing the cue timestamp, actual frame type, and expected IDR requirement. Because seamless ad transitions depend on keyframe alignment, any IDR inconsistency is classified as a downstream-remediable error, which causes the inline inspection module 210 to attach an error header so that the smart origin server 212 can perform processing pipeline 204 switching and/or insert a manifest discontinuity marker.

In an audio/video timing consistency check, the inline inspection module 210 extracts the decode-start timestamps for the audio and video tracks of each co-indexed livestream segment and computes the difference in start times. The inline inspection module 210 retrieves the configured tolerance, such as ±1 audio-frame or a specified lead/lag guarantee, and compares the measured timestamp delta against that tolerance. When the difference exceeds the configured tolerance, indicating a misalignment, the inline inspection module 210 generates an inspection result containing the audio and video start times, the measured offset, and the expected tolerance. This error is classified as an upstream error 314, triggering a logged alert for encoder-tuning workflows.

In a segment publishing cadence compliance check, the inline inspection module 210 records the wall-clock arrival time of each incoming livestream segment and compares the arrival time against the expected publish interval derived from the manifest template, such as 2 seconds per segment. For an initial livestream segment of a variant, the inline inspection module 210 captures the livestream segment arrival timestamp and the configured livestream segment duration. For each subsequent segment, the inline inspection module 210 calculates the elapsed time since the previous livestream segment arrival and evaluates whether this interval falls within an allowable jitter threshold around a nominal duration. When the measured interval exceeds the threshold, indicating late publishing or is significantly shorter, the inline inspection module 210 generates an inspection result containing the expected and actual arrival intervals and the magnitude of the deviation. Because segment-cadence violations reflect upstream encoder 206 or network performance issues that cannot be corrected in real time by downstream switching, the error is classified as an upstream error 314, and a logged alert can be generated and utilized to perform encoder-parameter tuning and pre-event calibration.

In an invalid-segment detection check, the inline inspection module 210 attempts to parse each incoming fragmented-MP4 livestream segment container structure, verifying the presence and correct ordering of required boxes, such as moof and mdat, and ensuring compliance with CMAF rules (e.g., valid box sizes, no unexpected nested boxes, etc.). When parsing fails or required boxes are missing, indicating an empty, malformed, or otherwise non-conformant segment, the inline inspection module 210 generates an inspection result identifying the structural violation, affected variant, and livestream segment number. This error is classified as a downstream-remediable error 312, which causes the inline inspection module 210 to attach an error header and drop the invalid segment so that the smart origin server 212 can switch to an error-free processing pipeline 204 or insert a manifest discontinuity marker.

In a caption continuity check, the inline inspection module 210 ensures that closed-caption or subtitle data active at the end of one livestream segment resumes at the beginning of the next. The inline inspection module 210 extracts caption cue start and end timestamps, and the inspection logic verifies that any caption flagged as “open” in segment N is carried over into segment N+1 without interruption or timestamp drift. Any truncation or misalignment, such as a caption ending prematurely or restarting with an incorrect offset, is flagged as an error.

In a SCTE-35 duration repetition check, the inline inspection module 210 validates that splice messages indicating ad-break or program-segment durations are consistently repeated across each segment within a specified interval. Upon parsing an SCTE-35 cue with a “break duration” descriptor, the inline inspection module 210 calculates the number of segments covered by the duration and confirms that the corresponding cue message appears in every segment throughout the interval. A missing or omitted cue in any expected segment flags an error.

### Method Diagrams

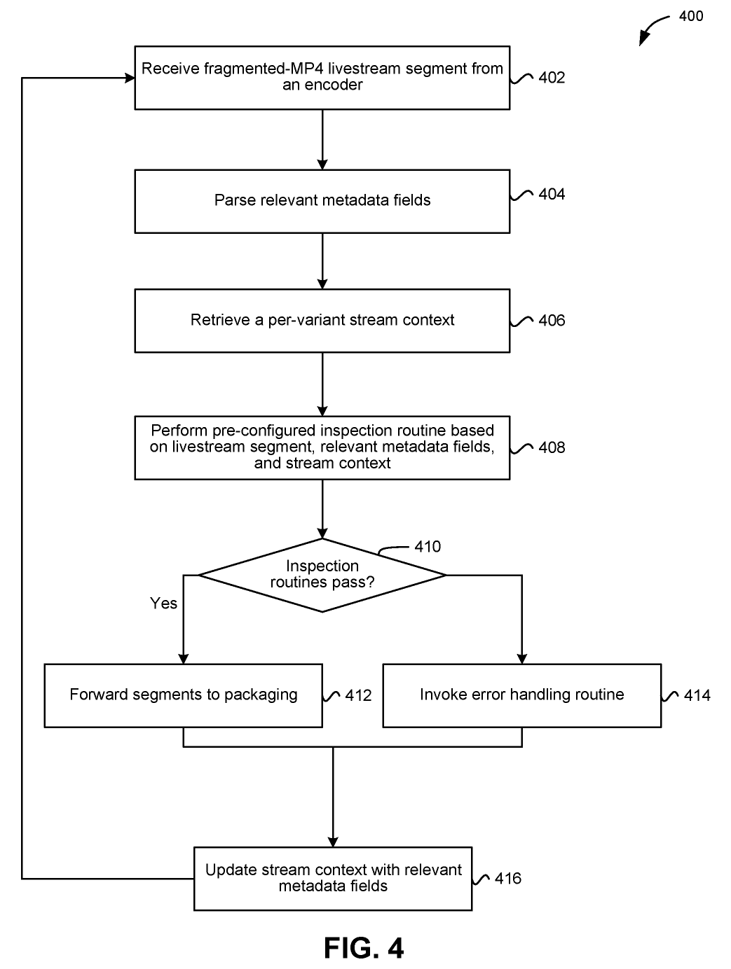

FIG. 4 illustrates a flow diagram of a method 400 for real-time inline segment inspection of a given variant stream within a packaging pipeline, according to various embodiments. As shown in FIG. 4, at step 402, a fragmented-MP4 livestream segment for a given variant stream is received from an encoder 206 into packager 208 (e.g., as described above in conjunction with FIGS. 1-3). At step 404, an inline inspection module 210, via a metadata parser module 302, parses relevant metadata fields 322 from the incoming livestream segment (e.g., as described above in conjunction with FIGS. 1-3).

At step 406, the inline inspection module 210 retrieves a per-variant stream context 320, based on previously stored relevant metadata fields 322 from previous livestream segments (e.g., as described above in conjunction with FIGS. 1-3). At step 408, the inline inspection module 210 via the invoke inspection module 304, performs the configured suite of pre-configured inspection routines by comparing the parsed relevant metadata fields 322 against the stream context 320 (e.g., as described above in conjunction with FIGS. 1-3).

At step 410, the inline inspection module 210 checks if the pre-configured inspection routines have passed. If the pre-configured inspection routines have passed, then the processing continues at step 412. Otherwise, if the pre-configured inspection routines have not passed, then the flow proceeds to step 414 (e.g., as described above in conjunction with FIGS. 1-3). At step 412, if all pre-configured inspection routines pass, the livestream segment is forwarded to the packaging stage of packager 208 for containerization, DRM application, and a manifest update (e.g., as described above in conjunction with FIGS. 1-3).

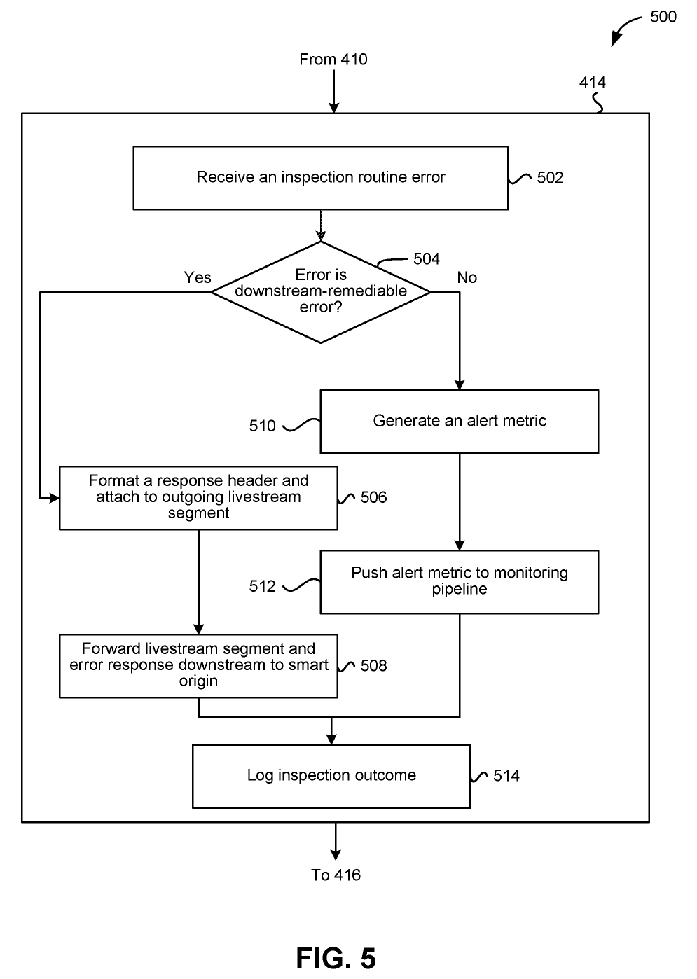

At step 414, for any pre-configured inspection routine failure, an error-handling routine is invoked via error logging module 310 to classify the failure, attach downstream-remediable or upstream error metadata, and log the incident for real-time remediation or offline analysis (e.g., as described above in conjunction with FIGS. 1-3). In some embodiments, based on the error type, the error-containing livestream segment is also forwarded to packaging. The error handling routine 414 is further described in detail in conjunction with FIG. 5.

At step 416, the stream context 320 associated with the given variant stream is updated to reflect the relevant metadata fields 322 of the processed livestream segment to prepare for inspection of subsequent segments (e.g., as described above in conjunction with FIGS. 1-3). The method flow repeats for subsequent livestream segments of a given variant.

FIG. 5 illustrates a flow diagram of a method 500 for an error handling routine for a given stream variant and livestream segment within a packaging pipeline, according to various embodiments. As shown in FIG. 5, at step 502, an inspection routine error, including a variant identifier, segment sequence number, error code, and contextual metadata, is received by an error logging module 310 from an invoke inspection module 304 (e.g., as described above in conjunction with FIGS. 1-3).

At step 504, the error logging module 310 evaluates the received error to determine whether the error is a downstream-remediable error 312 or an upstream error 314 based on the inspection routine error information (e.g., as described above in conjunction with FIGS. 1-3).

At step 506, if the error is downstream-remediable error 312, the error logging module 310 formats a specific HTTP response header and attaches the response to the outgoing livestream segment response (e.g., as described above in conjunction with FIGS. 1-3). At step 508, the livestream segment, along with any attached error response header, is forwarded downstream to the smart origin server 212 for real-time remediation actions (e.g., as described above in conjunction with FIGS. 1-3).

At step 510, for upstream errors 314, the error logging module 310 generates an alert metric, capturing the variant identifier, segment sequence number, error code, and contextual details to trigger upstream tuning actions or operator notifications (e.g., as described above in conjunction with FIGS. 1-3). At step 512, the error logging module 310 pushes the alert metric to a monitoring pipeline or any other relevant upstream error-handling for off-stream remediation (e.g., as described above in conjunction with FIGS. 1-3).

At step 514, the error logging module 310 logs the inspection outcome to a centralized repository by persisting a timestamped record enabling historical trend analysis, dashboard metrics, and/or capacity planning (e.g., as described above in conjunction with FIGS. 1-3).

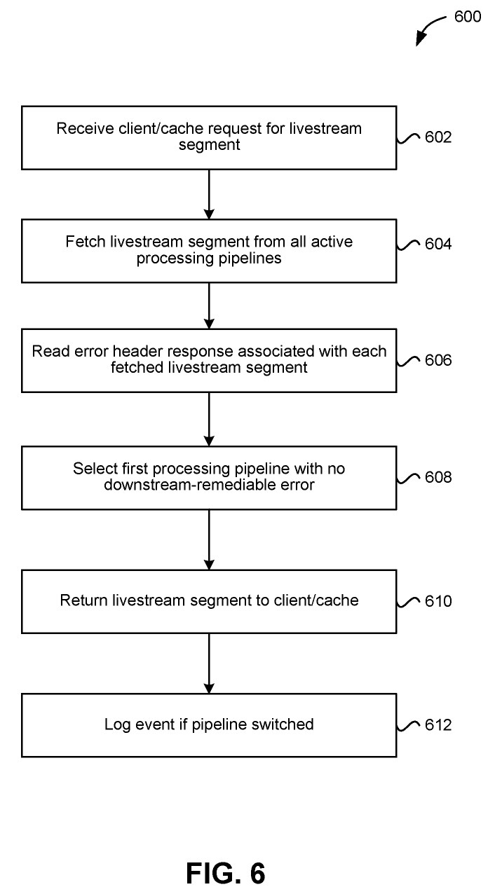

FIG. 6 illustrates a flow diagram of a method 600 for smart-origin 212 processing pipeline 204 selection, according to various embodiments. As shown in FIG. 6, at step 602, a smart origin server 212 receives a request for a given livestream segment from a downstream cache or client playback device (e.g., as described above in conjunction with FIGS. 1-3).

At step 604, the smart origin server 212 issues concurrent fetch requests for the requested livestream segment to each active processing pipeline and retrieves the fragmented-MP4 livestream segment responses from the associated packager 208 instance and/or error logging module 310 instance (e.g., as described above in conjunction with FIGS. 1-3).

At step 606, the smart origin server 212 reads the specific error metadata header attached to each fetched livestream segment response checking for any downstream-remediable errors (e.g., as described above in conjunction with FIGS. 1-3). At step 608, the smart origin server 212 evaluates the error headers and selects the first processing pipeline with a livestream segment response that carries no downstream-remediable error flags (e.g., as described above in conjunction with FIGS. 1-3).

At step 610, the smart origin server 212 returns the selected livestream segment to the requesting client or cache, inserting manifest-level discontinuity markers if the selected processing pipeline differs from the previous delivery (e.g., as described above in conjunction with FIGS. 1-3). At step 612, the smart origin server 212 logs the pipeline selection event, including original and fallback pipeline identifiers, segment number, and timestamp to a telemetry store, enabling analysis of failover occurrences and system performance (e.g., as described above in conjunction with FIGS. 1-3).

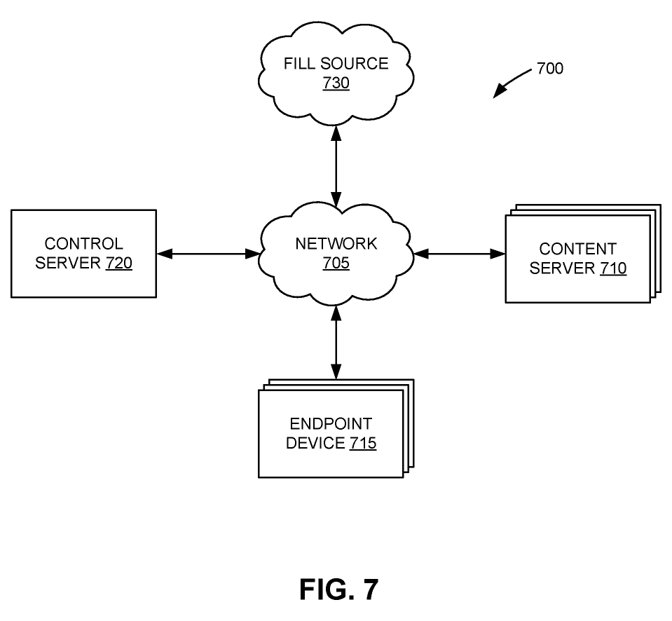

FIG. 7 illustrates a network infrastructure 700 used to distribute content to content servers 710 and endpoint devices 715, according to various embodiments of the invention. As shown, the network infrastructure 700 includes content servers 710 (e.g., the content servers 110 of FIG. 1), control server 720 (e.g., the control server 120 of FIG. 1), and endpoint devices 715 (e.g., the endpoint devices 115 of FIG. 1), each of which are connected via a communications network 705.

Each endpoint device 715 communicates with one or more content servers 710 (also referred to as “caches” or “nodes”) via the network 705 to download content, such as textual data, graphical data, audio data, video data, and other types of data. The downloadable content, also referred to herein as a “file,” is then presented to a user of one or more endpoint devices 715. In various embodiments, the endpoint devices 715 may include computer systems, set top boxes, mobile computer, smartphones, tablets, console and handheld video game systems, digital video recorders (DVRs), DVD players, connected digital TVs, dedicated media streaming devices (e.g., the Roku® set-top box), and/or any other technically feasible computing platform that has network connectivity and is capable of presenting content, such as text, images, video, and/or audio content, to a user.

Each content server 710 may include a web-server, database, and server application 817 configured to communicate with the control server 720 to determine the location and availability of various files that are tracked and managed by the control server 720. Each content server 710 may further communicate with a fill source 730 (e.g., the live source 130 of FIG. 1) and one or more other content servers 710 in order to “fill” each content server 710 with copies of various files. In addition, content servers 710 may respond to requests for files received from endpoint devices 715. The files may then be distributed from the content servers 710 or via a broader content distribution network. In some embodiments, the content servers 710 enable users to authenticate (e.g., using a username and password) in order to access files stored on the content servers 710. Although only a single control server 720 is shown in FIG. 7, in various embodiments multiple control servers 720 may be implemented to track and manage files.

In various embodiments, the fill source 730 may include an online storage service (e.g., Amazon® Simple Storage Service, Google® Cloud Storage, etc.) in which a catalog of files, including thousands or millions of files, is stored and accessed in order to fill the content servers 710. Although only a single fill source 730 is shown in FIG. 7, in various embodiments multiple fill sources 730 may be implemented to service requests for files. Further, as is well-understood, any cloud-based services can be included in the architecture of FIG. 7 beyond fill source 730 to the extent desired or necessary.

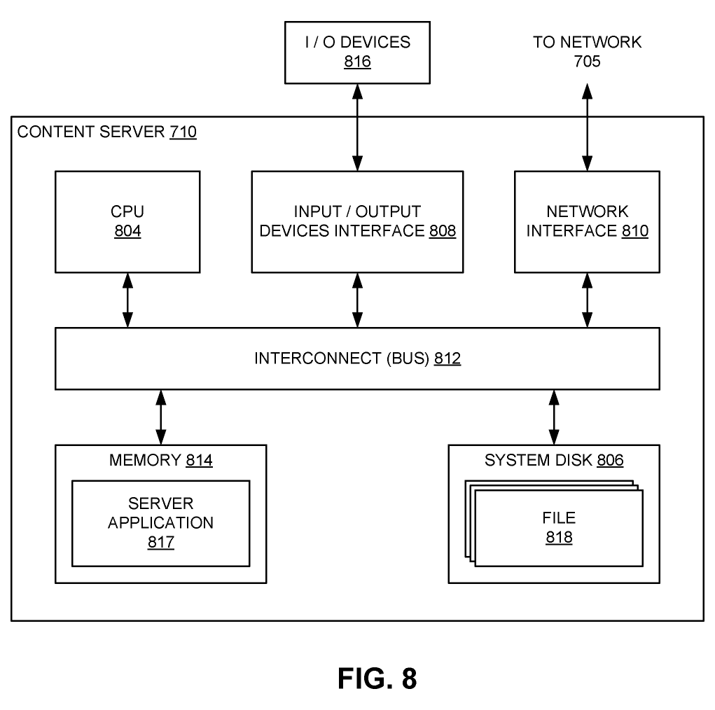

FIG. 8 is a block diagram of a content server 710 that may be implemented in conjunction with the network infrastructure 700 of FIG. 7, according to various embodiments of the present invention. As shown, the content server 710 includes, without limitation, a central processing unit (CPU) 804, a system disk 806, an input/output (I/O) devices interface 808, a network interface 810, an interconnect 812, and a system memory 814.

The CPU 804 is configured to retrieve and execute programming instructions, such as server application 817, stored in the system memory 814. Similarly, the CPU 804 is configured to store application data (e.g., software libraries) and retrieve application data from the system memory 814. The interconnect 812 is configured to facilitate transmission of data, such as programming instructions and application data, between the CPU 804, the system disk 806, I/O devices interface 808, the network interface 810, and the system memory 814. The I/O devices interface 808 is configured to receive input data from I/O devices 816 and transmit the input data to the CPU 804 via the interconnect 812. For example, I/O devices 816 may include one or more buttons, a keyboard, a mouse, and/or other input devices. The I/O devices interface 808 is further configured to receive output data from the CPU 804 via the interconnect 812 and transmit the output data to the I/O devices 816.

The system disk 806 may include one or more hard disk drives, solid state storage devices, or similar storage devices. The system disk 806 is configured to store non-volatile data such as files 818 (e.g., audio files, video files, subtitles, application files, software libraries, etc.). The files 818 can then be retrieved by one or more endpoint devices 715 via the network 705. In some embodiments, the network interface 810 is configured to operate in compliance with the Ethernet standard.

The system memory 814 includes a server application 817 configured to service requests for files 818 received from endpoint device 715 and other content servers 710. When the server application 817 receives a request for a file 818, the server application 817 retrieves the corresponding file 818 from the system disk 806 and transmits the file 818 to an endpoint device 715 or a content server 710 via the network 705.

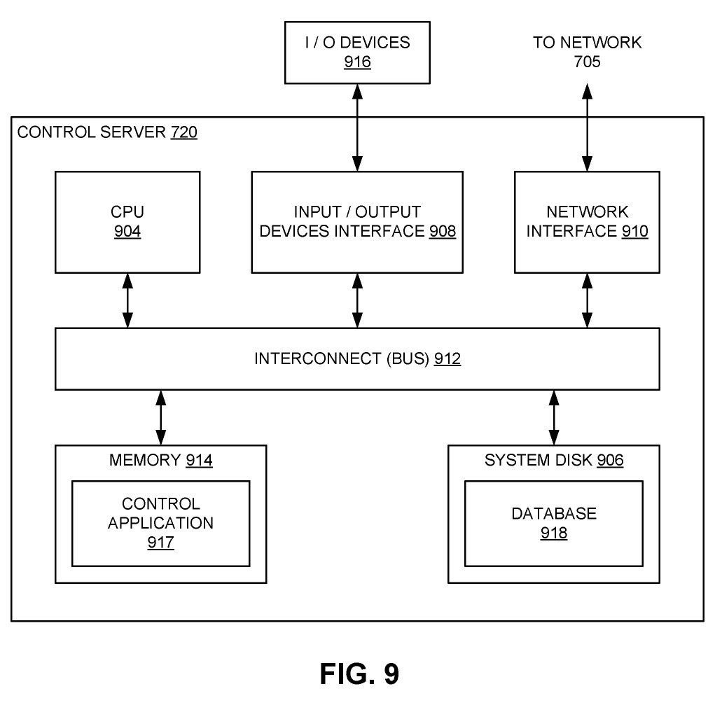

FIG. 9 is a block diagram of a control server 720 that may be implemented in conjunction with the network infrastructure 700 of FIG. 7, according to various embodiments of the present invention. As shown, the control server 720 includes, without limitation, a central processing unit (CPU) 904, a system disk 906, an input/output (I/O) devices interface 908, a network interface 910, an interconnect 912, and a system memory 914.

The CPU 904 is configured to retrieve and execute programming instructions, such as control application 917, stored in the system memory 914. Similarly, the CPU 904 is configured to store application data (e.g., software libraries) and retrieve application data from the system memory 914 and a database 918 stored in the system disk 906. The interconnect 912 is configured to facilitate transmission of data between the CPU 904, the system disk 906, I/O devices interface 908, the network interface 910, and the system memory 914. The I/O devices interface 908 is configured to transmit input data and output data between the I/O devices 916 and the CPU 904 via the interconnect 912. The system disk 906 may include one or more hard disk drives, solid state storage devices, and the like. The system disk 906 is configured to store a database 918 of information associated with the content servers 710, the fill source(s) 730, and the files 818.

The system memory 914 includes a control application 917 configured to access information stored in the database 918 and process the information to determine the manner in which specific files 218 will be replicated across content servers 110 included in the network infrastructure 100. The control application 917 may further be configured to receive and analyze performance characteristics associated with one or more of the content servers 710 and/or endpoint devices 715.

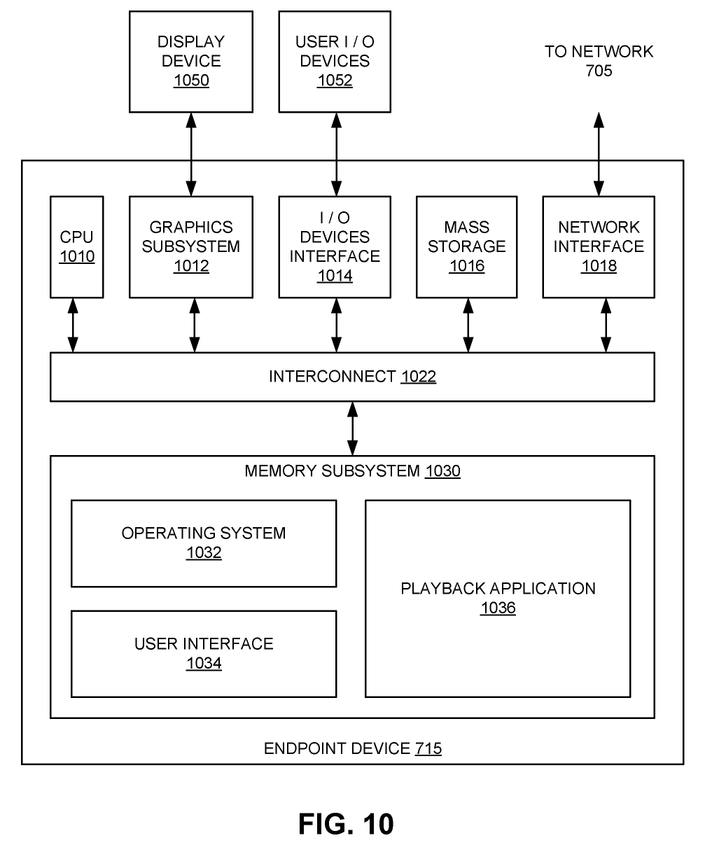

FIG. 10 is a block diagram of an endpoint device 715 that may be implemented in conjunction with the network infrastructure 700 of FIG. 7, according to various embodiments of the present invention. As shown, the endpoint device 715 may include, without limitation, a CPU 1010, a graphics subsystem 1012, an I/O device interface 1014, a mass storage unit 1016, a network interface 118, an interconnect 1022, and a memory subsystem 1030.

In some embodiments, the CPU 1010 is configured to retrieve and execute programming instructions stored in the memory subsystem 1030. Similarly, the CPU 1010 is configured to store and retrieve application data (e.g., software libraries) residing in the memory subsystem 1030. The interconnect 1022 is configured to facilitate transmission of data, such as programming instructions and application data, between the CPU 1010, graphics subsystem 1012, I/O devices interface 1014, mass storage 1016, network interface 1018, and memory subsystem 1030.

In some embodiments, the graphics subsystem 1012 is configured to generate frames of video data and transmit the frames of video data to display device 1050. In some embodiments, the graphics subsystem 1012 may be integrated into an integrated circuit, along with the CPU 1010. The display device 1050 may comprise any technically feasible means for generating an image for display. For example, the display device 1050 may be fabricated using liquid crystal display (LCD) technology, cathode-ray technology, and light-emitting diode (LED) display technology. An input/output (I/O) device interface 1014 is configured to receive input data from user I/O devices 1052 and transmit the input data to the CPU 1010 via the interconnect 1022. For example, user I/O devices 1052 may comprise one of more buttons, a keyboard, and a mouse or other pointing device. The I/O device interface 1014 also includes an audio output unit configured to generate an electrical audio output signal. User I/O devices 1052 includes a speaker configured to generate an acoustic output in response to the electrical audio output signal. In alternative embodiments, the display device 1050 may include the speaker. A television is an example of a device known in the art that can display video frames and generate an acoustic output.

A mass storage unit 1016, such as a hard disk drive or flash memory storage drive, is configured to store non-volatile data. A network interface 1018 is configured to transmit and receive packets of data via the network 705. In some embodiments, the network interface 1018 is configured to communicate using the well-known Ethernet standard. The network interface 1018 is coupled to the CPU 1010 via the interconnect 1022.

In some embodiments, the memory subsystem 1030 includes programming instructions and application data that comprise an operating system 1032, a user interface 1034, and a playback application 1036. The operating system 1032 performs system management functions such as managing hardware devices including the network interface 1018, mass storage unit 1016, I/O device interface 1014, and graphics subsystem 1012. The operating system 1032 also provides process and memory management models for the user interface 1034 and the playback application 1036. The user interface 1034, such as a window and object metaphor, provides a mechanism for user interaction with endpoint device 715. Persons skilled in the art will recognize the various operating systems and user interfaces that are well-known in the art and suitable for incorporation into the endpoint device 715.

In some embodiments, the playback application 1036 is configured to request and receive content from the content server 705 via the network interface 1018. Further, the playback application 1036 is configured to interpret the content and present the content via display device 1050 and/or user I/O devices 1052.

In sum, techniques are disclosed for implementing real-time inline inspections of livestreams within a packaging pipeline. In some embodiments, the disclosed techniques enable the implementation of one or more processing pipelines that contain an encoder and packager. An encoder generates encoded livestream segments, which are then received and processed by a packager. Prior to final packaging of each livestream segment, an inline inspection module extracts and maintains relevant metadata fields and a stream context of previous metadata fields. The inline inspection module then compares the relevant metadata fields against the stream context to identify at least one error. Upon identifying an error, the disclosed techniques enable a responsive action and propagation of alerts upstream and/or downstream, where appropriate. Errors that are actionable in real time can trigger downstream remediations. Remediation can include, for example, smart origin switching to an error-free livestream via a different processing pipeline. Unresolved or non-real-time upstream errors 314 can inform pre-livestream parameter adjustments to improve subsequent livestream quality. Livestream segments that pass inspection are packaged and forwarded downstream to origin servers, CDN edges, and ultimately clients.

At least one technical advantage of the disclosed techniques relative to the prior art is that the disclosed techniques enable real time inline inspection within a packager pipeline, thereby eliminating the need for a separate monitoring and inspection environment and duplication of livestream segments. The elimination of duplicate requests reduces network bandwidth consumption and decreases processing overhead previously necessary for parsing forked streams. Another technical advantage of the disclosed techniques over the prior art is that the disclosed techniques facilitate inspection of bit-exact livestream segments and capture errors in real time rather than relying on a forked feed of livestream segments. Such real-time error capture can help reduce or eliminate false positives and false negatives with respect to error detections. Therefore, livestream segments can be more accurately confirmed as error-free and compliant with the required format at publish time.
1. In some embodiments, a computer-implemented method for performing real-time inline inspections of livestream media comprises obtaining, by a packager, a livestream segment generated by an encoder; inspecting, by an inline inspection module operating within the packager, the livestream segment in real time based on information associated with the livestream segment; and classifying, by the inline inspection module, any error identified during the inspection to determine at least one remedial action.
2. The computer-implemented method of clause 1, wherein inspecting comprises parsing metadata fields from the livestream segment and comparing the metadata fields to a stream context derived from one or more previously obtained livestream segments from one or more livestream tracks.
3. The computer-implemented method of any of clauses 1-2, wherein classifying comprises distinguishing a downstream-remediable error from an upstream error to determine the at least one remedial action.
4. The computer-implemented method of any of clauses 1-3, wherein the at least one remedial action comprises attaching an error indicator to the livestream segment to specify downstream remediation.
5. The computer-implemented method of any of clauses 1-4, wherein the at least one remedial action comprises logging an error entry comprising at least one of a variant identifier, a segment sequence number, or contextual metadata.
6. The computer-implemented method of any of clauses 1-5, wherein inspecting comprises detecting a segment number discontinuity error by comparing a sequence number of the livestream segment to a previously stored sequence number.
7. The computer-implemented method of any of clauses 1-6, wherein inspecting comprises detecting a segment timing discontinuity error by comparing a decode time of the livestream segment to an expected decode time.
8. The computer-implemented method of any of clauses 1-7, wherein inspecting comprises detecting a sample-count discontinuity error by comparing an actual number of samples of the livestream segment to an expected number of samples of the livestream segment.
9. The computer-implemented method of any of clauses 1-8, wherein inspecting comprises detecting a misalignment between an ad-marker timestamp and an instantaneous decoder refresh frame.
10. The computer-implemented method of any of clauses 1-9, wherein inspecting comprises verifying continuity of captions or subtitles across consecutive livestream segments.
11. In some embodiments, a non-transitory computer-readable media stores instructions that, when executed by one or more processors, cause the one or more processors to perform real-time inline inspections of livestream media, by performing the operations of obtaining, by a packager, a livestream segment generated by an encoder; inspecting, by an inline inspection module operating within the packager, the livestream segment in real time based on information associated with the livestream segment; and classifying, by the inline inspection module, any error identified during the inspection to determine at least one remedial action.
12. The non-transitory computer-readable media of clause 11, wherein inspecting comprises parsing metadata fields from the livestream segment and comparing the metadata fields to a stream context derived from one or more previously obtained livestream segments from one or more livestream tracks.
13. The non-transitory computer-readable media of any of clauses 11-12, wherein classifying comprises distinguishing a downstream-remediable error from an upstream error to determine the at least one remedial action.
14. The non-transitory computer-readable media of any of clauses 11-13, wherein the at least one remedial action comprises attaching an HTTP response header to the livestream segment to cause at least one livestream segment to be received from an alternate processing pipeline.
15. The non-transitory computer-readable media of any of clauses 11-14, wherein the at least one remedial action comprises logging an error entry comprising at least one of a variant identifier, a segment sequence number, or contextual metadata.
16. The non-transitory computer-readable media of any of clauses 11-15, wherein inspecting comprises detecting a segment number discontinuity error by comparing a sequence number of the livestream segment to a previously stored sequence number.
17. The non-transitory computer-readable media of any of clauses 11-16, wherein inspecting comprises detecting a segment timing discontinuity error by comparing a decode time of the livestream segment to an expected decode time.
18. The non-transitory computer-readable media of any of clauses 11-17, wherein the at least one remedial action comprises inserting a manifest discontinuity marker to inform a downstream playback device of a detected error.
19. The non-transitory computer-readable media of any of clauses 11-18, wherein the at least one remedial action comprises transmitting an alert to a monitoring system to trigger adjustment of encoder parameters upstream.
20. In some embodiments, a computer system comprises one or more memories that include instructions, and one or more processors that are coupled to the one or more memories and that, when executing the instructions, are configured to perform real-time inline inspections of livestream media, by performing the operations of obtaining, by a packager, a livestream segment generated by an encoder; inspecting, by an inline inspection module operating within the packager, the livestream segment in real time based on information associated with the livestream segment, and classifying, by the inline inspection module, any error identified during the inspection to determine at least one remedial action.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a ““module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general-purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing real-time inline inspections of livestream media, the method comprising:
obtaining, by a packager, a livestream segment generated by an encoder;
inspecting, by an inline inspection module operating within the packager, the livestream segment in real time based on information associated with the livestream segment; and
classifying, by the inline inspection module, any error identified during the inspection to determine at least one remedial action.

2. The computer-implemented method of claim 1, wherein inspecting comprises parsing metadata fields from the livestream segment and comparing the metadata fields to a stream context derived from one or more previously obtained livestream segments from one or more livestream tracks.

3. The computer-implemented method of claim 1, wherein classifying comprises distinguishing a downstream-remediable error from an upstream error to determine the at least one remedial action.

4. The computer-implemented method of claim 1, wherein the at least one remedial action comprises attaching an error indicator to the livestream segment to specify downstream remediation.

5. The computer-implemented method of claim 1, wherein the at least one remedial action comprises logging an error entry comprising at least one of a variant identifier, a segment sequence number, or contextual metadata.

6. The computer-implemented method of claim 1, wherein inspecting comprises detecting a segment number discontinuity error by comparing a sequence number of the livestream segment to a previously stored sequence number.

7. The computer-implemented method of claim 1, wherein inspecting comprises detecting a segment timing discontinuity error by comparing a decode time of the livestream segment to an expected decode time.

8. The computer-implemented method of claim 1, wherein inspecting comprises detecting a sample-count discontinuity error by comparing an actual number of samples of the livestream segment to an expected number of samples of the livestream segment.

9. The computer-implemented method of claim 1, wherein inspecting comprises detecting a misalignment between an ad-marker timestamp and an instantaneous decoder refresh frame.

10. The computer-implemented method of claim 1, wherein inspecting comprises verifying continuity of captions or subtitles across consecutive livestream segments.

11. A non-transitory computer-readable media storing instructions that, when executed by one or more processors, cause the one or more processors to perform real-time inline inspections of livestream media, by performing the operations of:
obtaining, by a packager, a livestream segment generated by an encoder;
inspecting, by an inline inspection module operating within the packager, the livestream segment in real time based on information associated with the livestream segment; and
classifying, by the inline inspection module, any error identified during the inspection to determine at least one remedial action.

12. The non-transitory computer-readable media of claim 11, wherein inspecting comprises parsing metadata fields from the livestream segment and comparing the metadata fields to a stream context derived from one or more previously obtained livestream segments from one or more livestream tracks.

13. The non-transitory computer-readable media of claim 11, wherein classifying comprises distinguishing a downstream-remediable error from an upstream error to determine the at least one remedial action.

14. The non-transitory computer-readable media of claim 11, wherein the at least one remedial action comprises attaching an HTTP response header to the livestream segment to cause at least one livestream segment to be received from an alternate processing pipeline.

15. The non-transitory computer-readable media of claim 11, wherein the at least one remedial action comprises logging an error entry comprising at least one of a variant identifier, a segment sequence number, or contextual metadata.

16. The non-transitory computer-readable media of claim 11, wherein inspecting comprises detecting a segment number discontinuity error by comparing a sequence number of the livestream segment to a previously stored sequence number.

17. The non-transitory computer-readable media of claim 11, wherein inspecting comprises detecting a segment timing discontinuity error by comparing a decode time of the livestream segment to an expected decode time.

18. The non-transitory computer-readable media of claim 11, wherein the at least one remedial action comprises inserting a manifest discontinuity marker to inform a downstream playback device of a detected error.

19. The non-transitory computer-readable media of claim 11, wherein the at least one remedial action comprises transmitting an alert to a monitoring system to trigger adjustment of encoder parameters upstream.

20. A computer system, comprising:
one or more memories that include instructions; and
one or more processors that are coupled to the one or more memories and, when executing the instructions, are configured to perform real-time inline inspections of livestream media, by performing the operations of:
obtaining, by a packager, a livestream segment generated by an encoder;
inspecting, by an inline inspection module operating within the packager, the livestream segment in real time based on information associated with the livestream segment; and
classifying, by the inline inspection module, any error identified during the inspection to determine at least one remedial action.
